(19) United States
(12) Patent Application Publication
(10) Pub. No.: US 2006/0232139 A1
(43) Pub. Date: Oct. 19, 2006

(54) One button programmable timer

(76) Inventor: Paul Steven Mullin, Xenia, OH (US)

Correspondence Address: Paul Mullin, 476 North King Street, Xenia, OH, 45385, US

(21) Appl. No.: 11/105,302

(22) Filed: Apr. 14, 2005

(51) Int. Cl. H02B 1/24

(52) U.S. Cl. 307/116

(57) ABSTRACT

There is described a programmable electronic timer for control of household or industrial appliances, machines or lighting. The user of said device operates only a single momentary push button to perform all operation and programming steps. Optionally the device includes an indicator light for status feedback to the user. The single button serves as an on/off switch and programming input. When pressed the button turns the connected device off if it was previously on or alternately turns the connected device on if it was previously off. On and off button actions and the time during a 24 hour day that each occurred are recorded by the device. This record becomes the programmed sequence in the timer. On subsequent days the device repeats all on and off recorded events without user action.

### BACKGROUND OF THE INVENTION

Appliance and lighting timers of several designs are well known. All consist of an electrical inlet where power is supplied to the timer, a timing mechanism, an electrical power switching device and a power outlet to supply switched power to an appliance (an appliance may be a light fixture, machine or other electrically powered device). Also required is a method for the operator of such a timer to set a time schedule for desired on and off cycles of the timer.

Several physical forms are possible. A form to plug directly into a wall outlet with a built-in second outlet for the appliance to be controlled is common for use with lighting. A timer wired permanently into an electrical system with a constant electrical supply and an electrical connection to built in light fixtures is common in retail stores. Also possible is where the timing device has been built into the construction of an appliance such as a coffee maker. In all cases electricity from the supply is connected to the timer at all times. The electrical supply is switched through the power switching device by the timer to the light or appliance it is set up to control.

Simplest of these appliance timers is the electromechanical variety. These devices use a small synchronous motor to turn a typically 24 hour duration mechanical timing mechanism. The mechanism actuates a mechanical switching device as it is moved by the motor. The user must first set the correct time of day by adjusting the mechanical timing mechanism. Then the user may set slides, inserts or dials to configure the device to turn on and off the connected appliance when desired. The motor turns the timing mechanism using the frequency of the supplied AC power as a time base.

Another type of timer uses an integrated circuit, possibly a microcontroller. In this case the incoming power is used to generate a low voltage power supply for the integrated circuit and user interface. The integrated circuit then controls a power switching device such as a relay or TRIAC to switch power on and off to the appliance under control. The user interface may consists of several buttons or knobs and a feedback mechanism such as a display or lights. The user, as with the electromechanical timer, must set the time of day in addition to the times of desired on and off cycles. The integrated circuit may use the incoming power AC frequency to keep track of the time of day as with the electromechanically timer above. Alternately the integrated circuit may use it's own time base generation circuit to keep track of the time of day. The integrated circuits time base is typically a quartz crystal, ceramic resonator or other highly accurate oscillator.

All of the aforementioned designs have a significant drawback. They all require the user to set the time of day in addition to setting on and off times. The setting of the time of day can be a confusing process. It involves turning a dial to find the right time in a 24 hour scale or pushing small buttons and reading a display much like setting a digital clock. Typically these timing devices are not kept in the open with easy access. Plugged in to the wall outlet or hidden behind an appliance the dial or buttons can be difficult to see and operate. When built into an appliance the dial or display is kept out of sight for aesthetics.

### BRIEF SUMMARY OF THE INVENTION

The invention described solves the major drawback of other designs. There is no need to set the current time of day to use the invention. In addition the inventions user interface used to set the on and off times is exceedingly simple, only a single button. Single button operation means that the timer may be located in difficult to reach locations (at floor level, behind furniture etc.) With this invention it is possible to build the timing unit into a standard appliance such as a lamp and replace the existing switch with the timer input switch. One can now put the single button in plain view without affecting the look of the appliance. The timer programming button also operates the appliance and therefore can replace the normal decorative appliance switch.

In it's most basic form the invention begins timing a 24 hour cycle as soon as it is connected to the electrical supply. When the button is pressed the output of the power switching device is caused to change states, on to off, or conversely off to on. Each time the user presses the button the time is recorded inside the invention. 24 hours of user operation are recorded, starting from the first button press. After that first 24 hour period the timer simply repeats the recorded pattern. Because on and off cycles are repeated on a daily basis and recorded when the user pushes the button there is no need for the invention to be programmed with the actual time of day. This eliminates all the complications of existing timing devices.

### BRIEF DESCRIPTION OF THE DRAWINGS

FIG. 1 is a block diagram of a typical appliance or lighting timer

FIG. 2 is the electrical schematic of the invention

FIG. 3 is the electrical schematic of the invention including an optional user feedback lamp

### DETAILED DESCRIPTION OF THE INVENTION

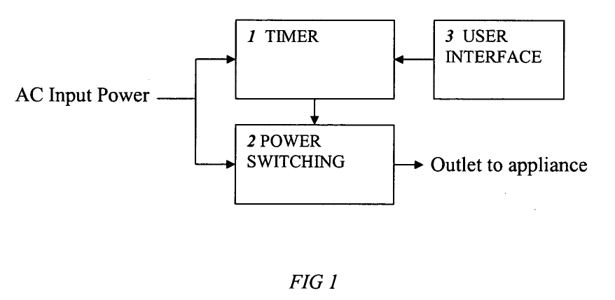

The invention described here, and most appliance timing devices, can be represented by the block diagram of FIG. 1. AC input power supplies energy for the timer (1) to operate and track the time of day. The timer actuates a switching device (2) to switch power on and off from the AC input to the appliance outlet. Finally, some type of user interface is required for the device to be programmed with the users desired on and off times.

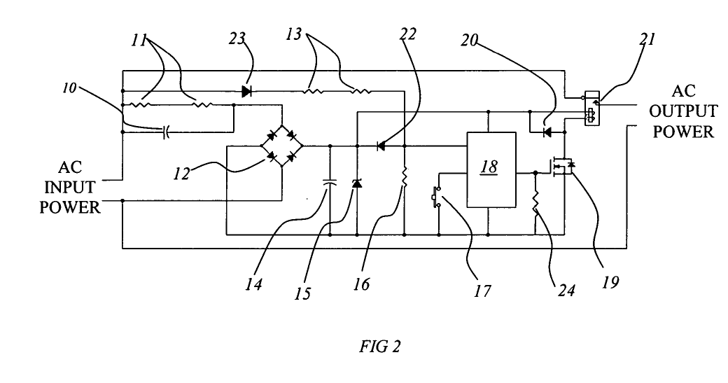

The invention circuit diagram is shown in FIG. 2. Capacitor 10 is wired in series with the AC input source. Power is transferred through capacitor 10 and bridge rectifier 12 to charge capacitor 14 to a dc voltage for providing power to the remainder of the circuit. Resistors, 11, discharge capacitor 10 in the event the AC supply is disconnected. The size of capacitor 10 is selected to provide enough power to the remainder of the circuit when the circuit is drawing its maximum current. When the remainder of the circuit is in such a state as to draw less than its maximum current diode 15 prevents the excess power supplied by capacitor 10 from charging capacitor 14 above the desired supply voltage. When the circuit operation is such that minimal power is consumed the excess power is dissipated in diode 15.

The integrated circuit, 18, is a small microcontroller in the preferred embodiment. However it could be a custom integrated circuit or other programmable device. Microcontrollers are available today that have self-contained timing generation, read only memory and random access memory. In this design such a microcontroller only requires that power is supplied for operation. The dc voltage present across diode 15 supplies power to the microcontroller. Two connections to the microcontroller are used for input and a third for output. Push button switch 17 is the single user interface button. Because the microcontroller input includes an internal resistor from the input to the positive power supply the button may be connected directly to the input.

A second input is used for timing. The internal microcontroller oscillator is not accurate enough to maintain the time of day for more than two days. For this reason the time of day is based on the AC line frequency. The AC line is sensed through resistors 13 and 16 that form a resistor divider sending a pulse to the microcontroller input for every line cycle. Diode 23 prevents the microcontroller input from being driven below ground potential. Diode 22 prevents the input from reaching a positive voltage that could damage the microcontroller. One output from the microcontroller drives the gate of the mosfet switch 19 (resistor 24 ensures that the mosfet is off if the microcontroller is not functioning). The mosfet in turn switches current to relay 21. Relay 21 has output contact sufficient to switch line voltage and current to the external appliance under control. Diode 20 protects the mosfet from the inductive spike when the relay is de-energized.

With suitable programming obvious to one skilled in the field the microcontroller needs only these three connections to the circuit for the invention to operate as described. User input through the push button. Time of day tracked by counting line cycles and one output to switch the appliance on and off as required.

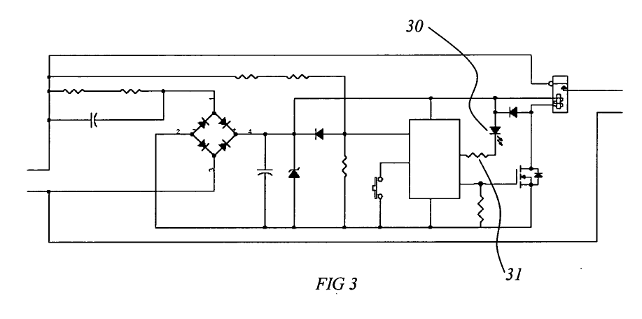

A second output pin may be used to directly drive a small light emitting diode lamp to be used as feedback to the user. This is shown in FIG. 3. Light emitting diode 30 is energized through resistor 31 by a second output of the microcontroller. Said light emitting diode could also be a beeper device to generate an audible feedback.

The circuit looses power quickly when disconnected from the AC supply. The value of capacitor 14 can be increased to sustain power though short outages. Even then the circuit will not be able to track the time of day accurately during the outage with out the AC line cycle. It is also possible to include a backup battery to keep the circuit active for long time periods without AC power. In this case a precision crystal would be used to provide a clock for the time of day counter when operating without the AC input. This is not preferred only doe to the extra cost of the battery and crystal components.

The user may press the button at any time after the first 24 hour period to operate the appliance as normal. The invention integrates new on and off times into its existing program. In this way the timer continually learns the users desired on and off patterns. To reset the timer and start a new learning cycle the user disconnects power for several minutes. When re-connected the invention is ready to record the first 24 hour period again.

Timers used today often need the time of day reset or adjusted. The timing mechanisms are not perfectly accurate and drift from the true time over weeks of use. Or short power outages cause lost time. Daylight savings time is usually not accounted for making the user change timers in addition to clocks. Because the invention described here is constantly learning use patterns it never needs reset or updated. It naturally mimics the users patterns as they change from week to week and season to season.

Many timing devices are used to control lighting in order to make a house looked lived in when the occupants are away. The invention described automatically does this once it has been in use for 24 hours to learn an on/off cycle pattern. To make the light switching even more realistic the timer may be programmed to alter the on/off times from day to day. The timer may use multiple days worth of learned on/off cycles to determine a time range each switching event should take place during. Then each day a random time inside of that range is picked. The effect is to make the light continue cycling on and off as if a person were there actuating the switch.

The timer will loose it's memory and the time of day during a long power outage. If this happens while the user is away it is undesirable to have the lights simply stay off. Therefore the timer may be designed to start a random lighting pattern in the event of power loss. This way when the power is restored at least the connected light will cycle on and off periodically.

In use on some appliances the user may desire the invention to change patterns during the two weekend days. For example a radio used to wake the household during the week should turn on later in the morning during the weekend. In this case the user does not want the invention to use every day to adjust the on/off cycle times. The user wants distinctly different patterns for the week and weekend. To accomplish this the invention only needs to be signaled when the weekend begins. Then a pattern for the week days can be learned separately from a pattern for the weekend. The invention optionally includes a small LED lamp for user feedback (FIG. 3). The user presses and holds the inventions button for several seconds until this LED blinks. This marks the beginning of the 48 hour weekend and a separate on/off pattern from the week days.

Alternatively the timer can be designed to track on and off cycles over a 7 day period. Repeat cycles would then be seven days instead of 24 hours.

I claim:

1. An appliance, including lighting, timer using a single push button for operation of the appliance and for programming the timer for future unattended operation of the appliance.

2. The electronic device of claim 1 where timing on and off cycles are repeated on a 24 hour cycle.

3. The electronic device of claim 1 where the device includes an indicator light or audible indicator for use as feedback to the operator of said device.

4. The electronic device of claim 1 where timing on and off cycles are repeated on a 7 day cycle.

5. The electronic device of claim 1 where timing on and off cycles are randomly varied within limits to make household lighting appear to be operated by a person.

6. The electronic device of claim 1 where separate 24 hour timing cycles are used during weekdays versus weekend days.

7. The electronics device of claim 1 where the device plugs directly into a wall outlet and includes a secondary outlet of the same type to connect the appliance to be under the devices control.

8. The electronics device of claim 1 where the device is built into an appliance or lighting fixture as to be an integral part of the appliance or fixture and its function.
